(19) United States
(12) Patent Application Publication
(10) Pub. No.: US 2010/0044169 A1
(43) Pub. Date: Feb. 25, 2010

(54) PIN CAP FOR A CALIPER ASSEMBLY

(75) Inventor: Muhammad Farooq, Farmington Hills, MI (US)

Correspondence Address: DOBRUSIN & THENNISCH PC, 29 W LAWRENCE ST, SUITE 210, PONTIAC, MI, 48342, US

(73) Assignee: Akebono Corporation (North America), Elizabethtown, KY (US)

(21) Appl. No.: 12/198,444

(22) Filed: Aug. 26, 2008

Related U.S. Application Data
(60) Provisional application No. 61/091,472, filed on Aug. 25, 2008.

(51) Int. Cl. F16D 65/02; B60T 1/06

(52) U.S. Cl. 188/73.44; 188/18 A

(57) ABSTRACT

The present invention is predicated upon improved vehicle brake assemblies, caliper assemblies, or combinations thereof, having at least one slide pin including an exterior surface and a first end, a caliper body including at least one pin bore for receiving the at least one slide pin at an inboard end, the at least one pin bore has an exterior surface and a cap groove that includes a groove wall defining a recess into the exterior surface of the at least one pin bore, and at least one pin cap that includes an edge portion that is engageable with the groove wall of the cap groove and a hinge portion extending in between the edge portion and a lid portion, the hinge portion including at least one bend that displaces the lid portion relative to the hinge portion to allow for deformation of the at least one pin cap.

### CLAIM OF PRIORITY

The present invention claims the benefit of the priority of the filing date of U.S. Provisional Application Ser. No. 61/091,472 filed Aug. 25, 2008, which is herein incorporated by reference for all purposes.

### FIELD OF THE INVENTION

The present invention generally relates to pin caps and more particularly to an internal pin cap that is especially suited for use in a brake caliper assembly.

### BACKGROUND OF THE INVENTION

Current disc brake systems generally employing reverse pin type calipers, which include external type pin caps, external boot seals, or both to seal the slide mechanism are typically prone to being becoming loosened, disengaged from the caliper, or otherwise. For example, in one problematic aspect during shipment of the calipers, these caps may be “knocked off” through contact with other components being shipped together. More specifically, it may be assumed that the caliper body may be sliding axially during shipping and since the slide pin is typically fixed to the support bracket, any motion, contact, or otherwise in the caliper body may cause the slide pin to extend outside of the caliper body opening (e.g., through hole) so as to protrude into the external pin cap area. Accordingly, this may essentially force the external pin cap to dislodge from the caliper body, which may expose the slide mechanism to the surrounding environment and cause the caliper to seize to function (e.g., from corrosion, particle build-up, or otherwise). In some attempts to solve this problem caliper manufacturers have significantly increased pin bore such that it would not protrude beyond the pin opening, however at increased costs. It is appreciated that increasing the pin bore significantly may not be feasible due to tight packaging between the caliper and the suspension components.

In another problematic aspect at brake corner assembly, the external pin cap may be vulnerable to be knocked-off. As such, extreme caution by the assembly worker may be required when handling a caliper with an external pin cap. In one specific example, customers have complained that during installing the brake mounting bolts, the torque gun may contact the external pin cap such that they are knocked off the caliper.

In another problematic aspect, use of external pin caps formed of certain rubbers may be vulnerable to stone/rock damage during vehicle operation.

In yet another problematic aspect, some external pin cap may include rock pecking protection which may cause interrupted machining of the external groove when rock pecking protection casting tab is present on rear caliper.

In yet another problematic aspect, external pin cap assemblies may further manufacturing such as including a spot facing on the slide pin opening of the pin bore.

It is appreciated that various pin cap designs have been provided in U.S. Pat. Nos. 4,235,313; 4,334,598; 4,458,790; 4,530,506; 4,557,354; 4,650,039; 4,678,064; 4,662,484; 4,768,626; 4,926,979; 5,040,642; 5,086,886; 5,090,520; 5,111,914; 5,183,136; 5,299,665; 5,355,774; 5,927,466; and 6,244,142 and EP Patent Application 0510742A1, which are herein incorporated by reference for all purposes.

Therefore, an object of the present invention is to provide an internal pin with a deformable portion for a caliper assembly that will assist in overcoming some or all of the above problems associated current pin cap designs.

### SUMMARY OF THE INVENTION

The present invention seeks to improve upon prior brake systems and particularly the pin cap configuration of caliper assemblies thereof by providing an improved pin cap design having a deformable body. In one aspect, the present invention provides a caliper assembly for a disc brake that includes at least one slide pin including an exterior surface and a first end, a caliper body, and at least one pin cap. The caliper body includes at least one pin bore for receiving the at least one slide pin at an inboard end. The at least one pin bore has an exterior surface and a cap groove that includes a groove wall defining a recess into the exterior surface of the at least one pin bore. The at least one pin cap that includes an edge portion and a hinge portion. The edge portion is engageable with the groove wall of the cap groove. The hinge portion extends between the edge portion and a lid portion. The hinge portion includes at least one bend that displaces the lid portion relative to the hinge portion to allow for deformation of the at least one pin cap. Upon the first end of the at least one slide pin contacting the lid portion so as to deform the lid portion, the hinge portion displaces the edge portion to engage the groove wall of the cap groove such that the edge portion is substantially or completely maintained within the cap groove thereby substantially retaining the at least one slide pin within the at least one pin bore.

In another aspect, the present invention contemplates a caliper for a disc brake that includes at least one slide pin including an exterior surface and a first end, a caliper body, and at least one internal pin cap. The caliper body includes at least one pin bore for receiving the at least one slide pin at an inboard end. The at least one pin bore has an exterior surface and a cap groove that includes a groove wall defining a recess into the exterior surface of the at least one pin bore. The at least one internal pin cap includes a peripheral edge portion and a hinge portion. The peripheral edge portion is engageable with the groove wall of the cap groove and includes an outer portion and a displaceable inner portion. The outer portion generally conforms to the recess of the cap groove, wherein the outer portion includes a least one protrusion engaging the groove wall such that a seal is formed therebetween for assisting in peripherally sealing the at least one pin bore. The displaceable inner portion has at least one projection that is engageable with the exterior surface of the at least one slide pin to assist in substantially or completely maintaining the edge portion of the at least one pin cap within the cap groove. The hinge portion extends between the inner portion of the peripheral edge portion and a lid portion of the at least one pin cap. The hinge portion assists in displacing the inner portion of the peripheral edge portion to engage the exterior surface of the at least one slide pin. The at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore.

In another aspect, the present invention contemplates a caliper for a disc brake that includes a support bracket, at least one slide pin that includes an exterior surface, a caliper body, and at least one slide pin. The support bracket includes a pair of spaced apart frame members at opposite ends of the support bracket. The caliper body includes at least one pin bore for receiving the at least one slide pin at an inboard end portion. The at least one pin bore includes an exterior surface and a cap groove. The exterior surface of the pin bore has an inboard exterior surface portion nearest to the inboard end portion of the at least one bore and an outboard exterior surface portion. The cap groove has a groove wall extending between the inboard and outboard exterior surface portions. The groove wall defines a recess into the exterior surface of the at least one pin bore and includes an inboard groove wall portion that extends from inboard exterior surface portion, an outboard groove wall portion that extends from the outboard exterior surface portion, and an outer groove wall portion that extends therebetween. The at least one internal pin cap that includes a periperhal edge portion and a hinge portion. The peripheral edge portion has an outer portion and an inner portion. The outer portion generally corresponds to the cap groove for engaging the groove wall thereabout so that the outer portion assists in substantially or completely maintaining the edge portion within the cap groove. The outer portion includes a least one protrusion engaging the groove wall such that a peripheral seal is formed therebetween to assist in substantially or completely sealing at least a portion of the at least one pin bore. The inner portion has at least one projection that is engageable with the exterior surface of the at least one slide pin to assists in substantially or completely maintaining the at least one pin cap within the pin bore. The hinge portion extends between the inner portion of the peripheral edge portion and a lid portion of the at least one pin cap. The lid portion radially extends from the hinge portion to substantially or completely enclose the at least one pin bore such that the at least one pin cap to assist in substantially or completely preventing exposure from the surrounding environment. The hinge portion includes at least one bend that displaces the lid portion relative to the hinge portion to allow for deformation of the at least one pin cap. The at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore. The cap groove is positioned at a distance from the inboard end of the at least one pin bore such that the at least one pin cap prior to, during, or after deformation is substantially or completely maintained within the at least one pin bore. Upon the first end portion of the at least one slide pin engages the lid portion so as to displace the lid portion outward, the inner portion of the edge portion is displaced towards the at least one slide pin such that the at least one projection engages the exterior surface of the at least one slide pin to assist in substantially or completely preventing the pin cap from being removed from the at least one pin bore. The lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface.

In yet another aspect, any of the aspects of the present invention may be further characterized by one or any combination of the following features: the edge portion extends peripherally along the cap groove so as to form a seal therein; the edge portion includes an outer portion having at least one protrusion for engaging the groove wall of the cap groove to assist in substantially or completely maintaining the edge portion of the at least one pin cap within the cap groove; the outer portion of the edge portion includes an inboard protrusion and an outboard protrusion that are spaced apart for engaging the groove wall of the cap groove; the edge portion includes an inner portion having at least one projection that is engageable with the exterior surface of the at least one slide pin; upon the first end of the at least one slide pin contacting the lid portion of the at least one pin cap so as to displace the lid portion inboard, the inner portion of the edge portion displaces inward towards the exterior surface of the at least one slide pin so that the at least one projection engages the exterior surface of the at least one slide pin to assist in substantially or completely preventing the pin cap from being removed from the at least one pin bore; the at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore; the lid portion radially extends from the hinge portion to generally enclose the at least one pin bore such that the at least one pin cap forms a seal therein to assist in substantially or completely preventing exposure from the surrounding environment; the cap groove is positioned at a distance from an inboard end of the at least one pin bore such that the at least one pin cap prior to, during, or after deformation is substantially or completely within the at least one pin bore; the lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface; the cap groove forms a generally L-shaped groove profile that extends to an inboard end portion of the at least one pin cap such that a securement member at least partially encapsulates the inboard end of the at least one pin cap and an outer groove wall portion of the cap groove, and wherein the securement member including a wall portion that engages the outer groove wall portion along an outer surface and is attached to the edge portion along an inner surface, and further wherein the edge portion is generally flat an extends generally parallel to the groove wall; the edge portion includes an outer portion having at least one protrusion for engaging at least one depression forming in the groove wall of the cap groove, an inner portion having a lip portion engaging the groove wall of the cap groove, and an insert member being at least partially disposed with the edge portion of the at least one pin cap, wherein the at least one protrusion, the lip portion, the insert member, or any combination thereof assists in substantially or completely maintaining the at least one pin cap within the at least one pin bore; the exterior surface of the at least one pin bore includes an inboard exterior surface portion nearest to an inboard end of the at least one pin bore and an outboard exterior surface portion, with the cap groove extending therebetween, the inboard exterior surface portion is displaced radially outward of the outboard exterior surface portion, and the groove wall extends between the inboard and outboard exterior surface portions of the at least one bore, the groove wall including an inboard groove wall portion extending generally perpendicularly from the inboard exterior surface portion, and outboard groove wall portion extending generally perpendicularly from the outboard exterior surface portion, and an outer groove wall portion extending therebetween, the outer portion includes an inboard protrusion and an outboard protrusion that are spaced apart for engaging the groove wall of the cap groove to form the seal; upon the first end of the at least one slide pin contacting the lid portion of the at least one pin cap so as to displace the lid portion inboard, the inner portion of the edge portion displaces inward towards the exterior surface of the at least one slide pin so that the at least one projection engages the exterior surface of the at least one slide pin to assist in substantially or completely maintaining the edge portion of the at least one pin cap within the cap groove; or any combination thereof.

It should be appreciated that the above referenced aspects and examples are non-limiting as others exist with the present invention, as shown and described herein. For example, any of the above mentioned aspects or features of the invention may be combined to form other unique configurations, as described herein, demonstrated in the drawings, or otherwise.

### BRIEF DESCRIPTION OF THE DRAWINGS

FIG. 1 illustrates a perspective view of one embodiment of the present invention.

FIG. 2 illustrates a cross-sectional side view of the embodiment shown in FIG. 1.

FIG. 3A illustrates a cross-sectional top view of the embodiment shown in FIG. 1.

FIG. 3B illustrates an enlarged cross-sectional top view of the embodiment shown in FIG. 3A.

FIG. 4 illustrates a perspective view of another embodiment of the present invention.

FIG. 5 illustrates a cross-sectional side view of the embodiment shown in FIG. 4.

FIG. 6A illustrates a cross-sectional top view of the embodiment shown in FIG. 4.

FIG. 6B illustrates an enlarged cross-sectional top view of the embodiment shown in FIG. 6A.

FIG. 7A illustrates a perspective view of another embodiment of the present invention.

FIG. 7B illustrates a cross-sectional side view of the embodiment shown in FIG. 7A.

FIG. 8A illustrates a perspective view of another embodiment of the present invention.

FIG. 8B illustrates a cross-sectional side view of the embodiment shown in FIG. 8A.

### DETAILED DESCRIPTION OF THE INVENTION

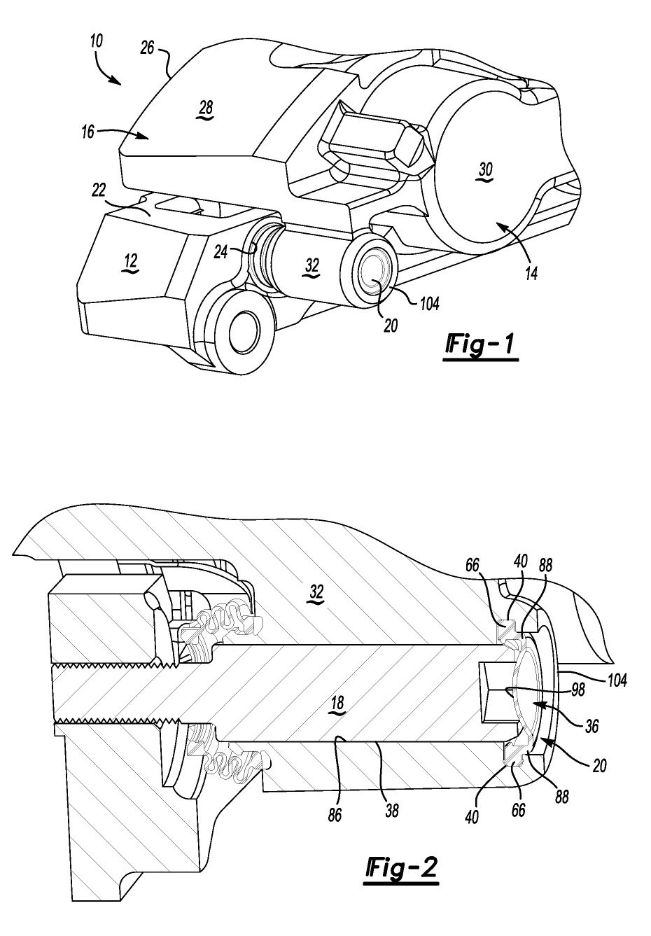

In a broad sense, the present invention is directed to an assembly for a brake system having a improved caliper for overcoming one or more of the problems associated with shipment of calipers prior to installation, installation of calipers, or manufacturing costs of caliper. Generally, the present invention is directed to an improved caliper that includes a novel generally internal pin cap design for installation into a groove of a pin bore such that when the caliper slides axially (e.g., during shipment of the caliper prior to installation thereof, or otherwise) so as to initiate contact between the slide pin and the pin cap, the slide pin deforms the pin cap thereby securing (e.g., “trapping”) the pin cap peripherally along the groove such that the pin cap may not be substantially of completely removed from the caliper (e.g., pin bore). In one aspect, the present invention is directed to an improved caliper 10 operable to apply a clamping force to a rotatable disc for an automotive vehicle. Though fewer or more components may be included in the caliper 10, it is generally contemplated that the caliper 10 with reference to FIGS. 1-6B will include a support bracket 12, inner and outer brake shoes (not shown), a piston 14, a caliper body 16, at least one slide pin 18, and at least one slide pin cap 20.

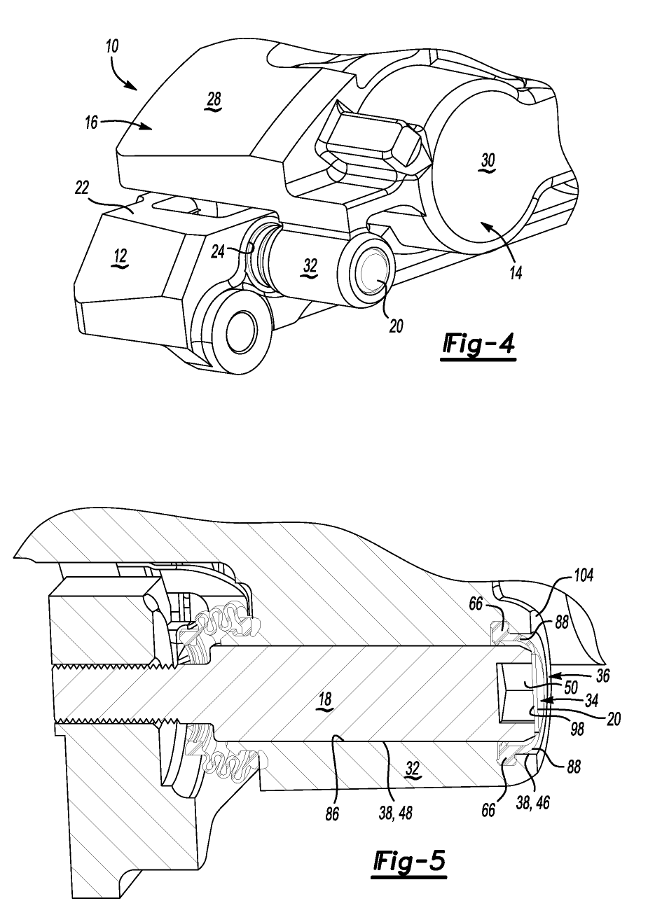

As shown in FIGS. 1 and 4, the caliper 10 typically will include the support bracket 18 having a pair of spaced apart frame members 22 at opposite ends of the support bracket 12. Each frame member 22 may have an internal surface with at least one arm extending therefrom. The arm may include an opening 24 (e.g., through hole) for receiving the slide pin 18. It is appreciated that when two or more arms are included, a spacing may be provided therebetween defined by the side walls of the two or more arms and the internal surface of the frame member 22. Generally both frame members 22 of the support bracket 12 may include the same number of arms extending therefrom, though not required. For example, there may be one arm, two arms, or more extending from each opposing frame member or one frame member may include more or less arms extending therefrom than the other frame member 22. The arms may vary in size (e.g., thickness relative to radial axis of the rotatable disc) such that one or more arms may encapsulate a larger portion of the respective slide pin 18 than another arm. It is appreciated that the opening 24 of the support bracket 12 may include a retention feature (e.g., threads, fastener, or otherwise) within the opening for securing an end of the slide pin 18 thereto, though not required.

For an illustrative caliper assembly, the caliper 10 may include two or more opposing spaced apart slide pins 18 that are removably mounted to the caliper 10. The slide pin 18 may be engaged with the openings of one or more caliper components (e.g., the support bracket 12, the inner brake shoe, the outer brake shoe, the caliper body 16, or any combination thereof) such that at least one of the caliper components engaged thereto may be configured to slide along the slide pin 18. The slide pin 18 may be formed of a metallic material, a polymeric material, a composite material, or otherwise. It is appreciated, when included, the slide pins 18 may be longitudinally extending members generally parallel to one another and to the rotational axis of the rotatable disc. The profile of the slide pin 18 may be a variety of differing shapes and sizes. The profile, size, weight, or otherwise of each slide pin 18 may be same or different. Preferably, the slide pins 18 are generally similar and may include a profile that is generally arcuate.

The slide pin 18 may include a retention feature (e.g., threads, fasteners, or otherwise) for securing the slide pin 18 to the caliper 10 (e.g., support bracket 12). In one aspect, the slide pin 18 may include a retention feature (e.g., at an end portion) having a tapered portion with a flange portion, a threaded portion, or otherwise for securement to the caliper 10. The retention feature may partially, substantially, or completely prevent the slide pins 18 from moving (e.g., sliding, rotating, or otherwise) through one or more openings receiving the slide pin 18 (e.g., through the opening of the support bracket 12 or otherwise). The slide pin 18 may include a recessed portion 50 opposite the retention feature (e.g., at an opposing end portion) for securing the slide pin 18 to the caliper 10.

The caliper 10 further includes the caliper body 16 slidably supported by slide pins 18 having the piston 14 operable to cause the inner and outer brake shoes to move towards one another for engaging the opposite sides of the rotatable disc. The caliper body 16 may include a finger portion 26 located in an exterior portion of the caliper 10, a bridge portion 28 located in a central portion of the caliper 10, and a piston portion 30 located in an interior portion of the caliper 10. The caliper body 16 may further include at least one boss portion 32. In one preferred embodiment the caliper body includes at least one pair of spaced apart boss portions 32 that may be located on opposite ends of the caliper body 16.

The boss portion 32 includes a pin bore 34 having an opening 36 (e.g., through hole) at an inboard end 104 to receive the slide pin 18 for movement of the caliper body 16 thereabout. The pin bore 34 further includes an exterior surface 38 and a cap groove 40 having groove wall 42 defining a recess into the exterior surface 38 of the pin bore 34. The exterior surface 38 defines a cavity (e.g., generally cylindrical or otherwise) for receiving the slide pin 18. The exterior surface 38 includes an inboard exterior surface portion 46 and an outboard exterior surface portion 48 with the shaped cap groove 40 (e.g., generally annular), therebetween. The cap groove 40 is outwardly displaced from the exterior surface 38 to define a cap groove profile forming an area adapted to receive at least a portion of the pin cap 20. Advantageously, the pin cap 20, the cap groove profile or both may configured to assist in sealing the peripheral of the pin bore 34, substantially or completely maintaining the portion of the pin cap 20 within cap groove 40, or a combination of both.

As shown in FIGS. 2-3B and 4-6B, various cap groove profiles (e.g., cross-sectional configurations) and locations within the exterior surface 38 of the pin bore 34 may be employed. The profile of the cap groove 40 can be a variety of differing shapes and sizes. As illustrative examples, the cap groove 40 may generally have a square groove profile, a triangular profile, a rounded profile, a stepped profile, multiple grooves with similar or differing profiles, or any combination thereof. The groove profile can also include a portion with a flat side wall, an arcuate side wall, a flat bottom, an arcuate bottom, a portion substantially resembling a U-shape, a portion substantially resembling a V-shape, or any combination thereof.

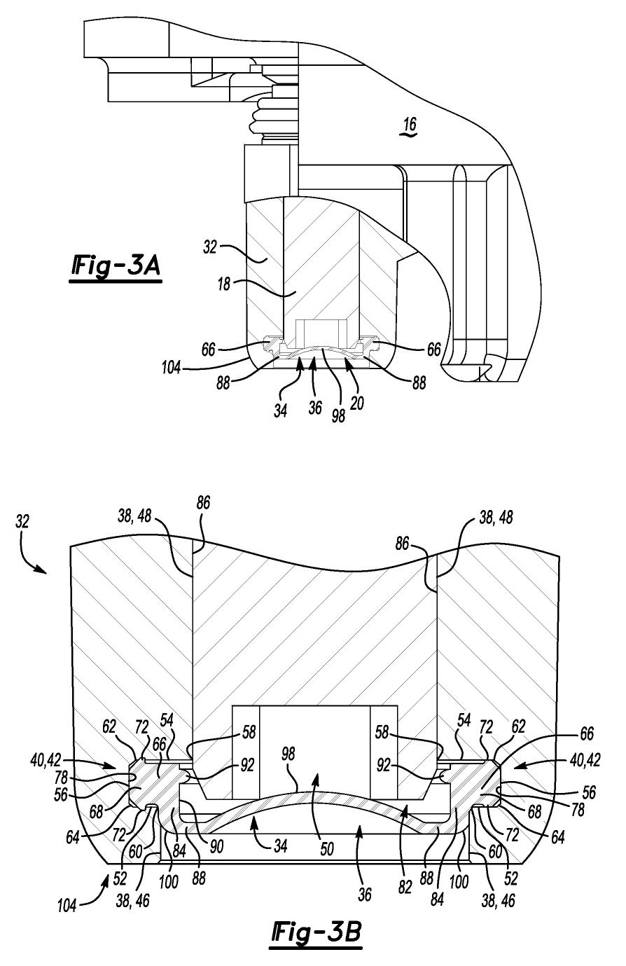

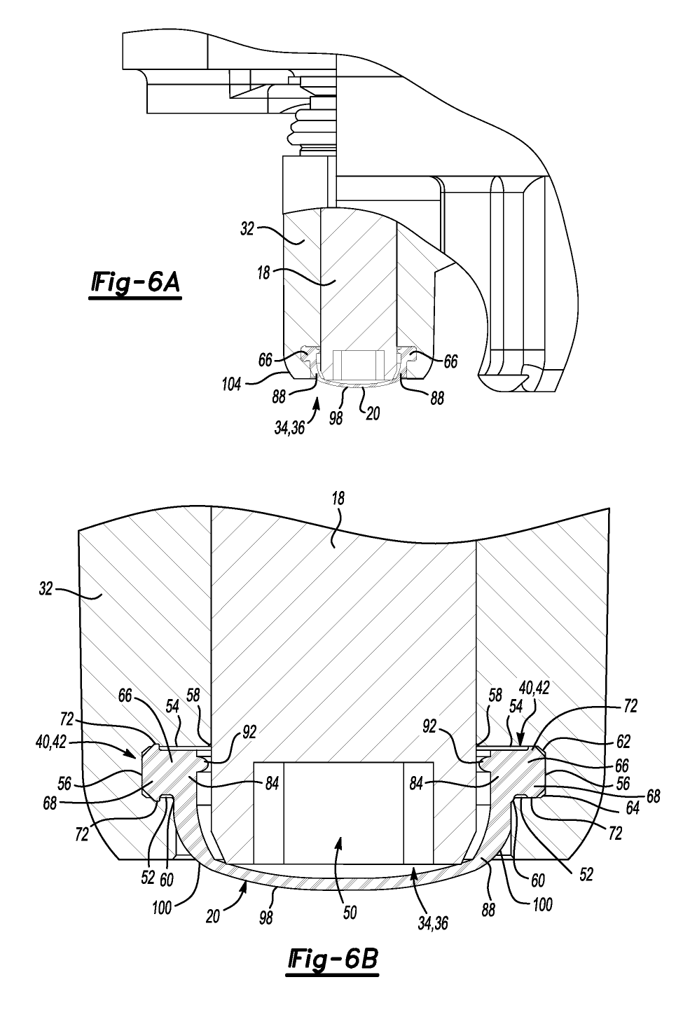

With reference to FIGS. 3B and 6B, enlarged representations of one specific cap groove 40 is shown that includes a generally square profile. It is contemplated that the groove wall may include an inboard wall portion 52 extending outward (e.g., generally perpendicularly) from the inboard exterior surface portion 46, an opposing outboard wall portion 54 extending outward (e.g., generally perpendicularly) from the outboard exterior surface portion 48, and an outer base wall 56 extending therebetween. The inboard wall portion 52, the outboard wall portion 54, the outer base wall portion 56, or any combination thereof may have a cross-section that may be flat, (e.g., sloping or otherwise), arcuate, or otherwise, or any combination thereof. The inboard and outboard exterior surface portions 46, 48 may extend to the inboard and outboard wall portions 54, 56, respectively through inner bends 58, 60. The inboard and outboard wall portions 54, 56 may extend to the outer base wall portion 56 through outer bends 62, 64. For example, one or both of the inner bends 58, 60, one or both of the outer bends 62, 64, or any combination thereof may be generally curved such as concave or convex, flat such as sloping or chamfered, apexed such as having a point or edge, or otherwise, or any combination thereof.

The caliper further includes at least one pin cap 20. The pin cap 20 may be formed of metallic, plastic, or a composite, or combinations thereof. The pin cap 20 may be formed partially or entirely of plastic such the pin cap 20 may be deformable so that it may be displaced to allow for movement of the caliper body along the slide pin 18. However, the pin cap 20 may also be relatively rigid such that as the pin cap 20 deforms, the pin cap may maintain its general shape and/or placement. For example, as the pin cap 20 deforms, at least a portion of the pin cap 20 remains relatively rigid so as to engage the pin bore 34 to assist in substantially or completely maintaining the pin cap 20 therein. More specifically, for example as discussed herein, in comparing a generally soft type cap (e.g., deformable such as rubber or otherwise) versus a generally hard type cap (e.g., rigid such as plastic, metal, or otherwise), packaging issues or compactness need to be addresses. It is believed that in order to avoid the slide pin contact with the hard type pin cap (possibly causing the pin cap to become “knock-off”), typically, the length of the pin bore may be extended by certain distance such that there is a greater gap between the end of the slide pin and the hard type pin cap. Optionally or as an alternative, when packaging may be an issue, another way to utilize the hard type pin cap may be to provide a shorter slide pin instead of extending the pin bore. Additionally, it is believed that this shorter slide pin may avoid contact between the hard type pin cap and the shorter slide pin; however a disadvantage that may arise when a shorter slide pin is utilized may be the loss of the engagement length of the slide pin with the pin bore. Accordingly, the shorter pin engagement may cause the caliper body caliper to tilt (e.g., droop) more because the shorter slide pin has a larger angle of freedom in the same clearance pin bore. Drooping of the caliper is not desirable due to potential increases in taper wear of linings, potential caliper rattle due to sagging (e.g., larger rocking motion), or otherwise. For example, the caliper that may not be square to the rotor (e.g., tilting or drooping) may further have a tendency to have caliper slide issues (e.g., locking of caliper) due to slide pin jamming at one or more various angles. As such, by utilizing an internal pin cap, pin cap “knock-off,” increased pin bore length, reduced slide pin length, or otherwise may be avoided.

The pin cap 20 includes an edge portion 66 that may be engageable with the cap groove 40 for substantially or completely maintaining the edge portion 66 therein. The edge portion 66 may be shaped in various forms. The edge portion 66 may be generally annular and includes an outer portion 68 generally engages (e.g., contacts) at least a portion of the groove wall 42. In one embodiment, the edge portion 66 may extend peripherally along the generally annular cap groove 40. Preferably, the outer portion 68 substantially conforms (e.g., corresponds, has a similar profile, or otherwise) to the recess of the cap groove 40 and may include a retention feature to assist in substantially or completely maintaining the edge portion 66 within the cap groove 40. The retention feature may include at least one protrusion 72. In one specific example as shown in FIGS. 3B and 6B, outer portion 68 includes an inboard protrusion 72 in an engaging relationship with the inboard wall portion 52 of the cap groove 40 and an outboard protrusion 72 in an engaging relationship with the outboard wall portion 54 of the cap groove 40 so that a peripheral seal is formed along the groove wall 42 of the cap groove 40 for partially, substantially, or completely sealing pin bore 34. At least a portion (e.g., outer portion 68) of the edge portion 66 may be appropriately dimensioned to form a seal thereabout to a portion (e.g., groove wall 42) of the cap groove profile. In one specific example, the outer portion 68 of the edge portion 66 may include opposing protrusions 72 (e.g., about an inboard outer portion and an outboard outer portion 76, respectively) with an outer diameter which may be larger than the outer portion 68 of the edge portion 66 without protrusions 72). The outer portion 68 of the edge portion 66 may further include an outer portion wall extending between the inboard and outboard outer portions 74, by bends 64, 62, respectively. One or both of the bends 64, 62 may be generally curved such as concave or convex, flat such as sloping or chamfered, apexed such as having a point or edge, or otherwise, or any combination thereof. In one embodiment, the cross-section of the outer portion 68 of the edge portion 66 may be generally a square shape having similar to the cap groove profile as discussed above. It is appreciated that other shapes, sizes, orientations, or otherwise may be possible.

The edge portion 66 may further include an inner portion 84 that may extend from the outer portion 68 of the edge portion 66 towards an exterior surface 86 of the slide pin 18. The inner portion 84 may include an outboard wall portion adjacent to (e.g., parallel) the outboard groove wall portion 54 of the groove wall 42 and an inboard portion that may extend to a hinge portion 88 of the pin cap 20. The inner portion 84 may further include an inner wall 90 generally opposing the outer portion wall 78, when included.

Upon deformation (e.g., displacement or otherwise) of the pin cap 20 (e.g., by way of contact with an end portion 82 of the slide pin 18, or otherwise), it may be possible that at least one of the inboard and outboard protrusions 72 may be further displaced towards the respective groove wall portions (e.g., 52, 54, or otherwise) so that frictional contact therebetween is increased thereby assisting in substantially or completely maintaining the edge portion 66 within the cap groove 40. The inner portion 84 (e.g., inner wall 90) of the edge portion 66 may include a retention feature to assist in substantially or completely maintaining the edge portion 66 within the cap groove 40. In one specific example the retention feature includes at least one projection 92 that may extend inwards towards the exterior surface 86 of the slide pin 18 and may be located along the inner wall 90 of the inner portion 84.

The edge portion 66 (e.g., outer portion 68, inner portion 84, protrusion 72, projection 92, or otherwise, or any combination thereof) may be configured to frictionally engage, for sealing purposes, securement purposes (e.g., maintaining edge portion within cap groove), or otherwise, on at least a portion of the groove wall 42 of the cap groove 40. The cap groove profile and the edge portion profile may be configured to engage one another to assist in substantially or completely maintaining the edge portion 66 within the cap groove 40 so that the slide pin 18 substantially remains within the pin bore 34 (e.g., during movement (e.g., sliding or otherwise) of the caliper body 16 along the slide pins 18).

As mentioned above, the pin cap 20 may include the hinge portion 88. The hinge portion 88 may extend between the edge portion 66 and a lid portion 98. The hinge portion 88 may assist in displacement (e.g., deformation, rotation, or otherwise) of the edge portion 66, the lid portion 98, or a combination of both upon contact by the slide pin 18 with the pin cap 20. The pin cap may be in compression such that a compression force by the hinge portion is formed to engage the exterior surface of the pin bore, the groove wall, or a combination of both so as to assist in substantially or completely maintaining the pin cap in position within the pin bore and/or from being removed therefrom.

With reference to one specific exemplary embodiment as shown in FIGS. 3B and 6B, the hinge portion 88 may extend from the inner bends 60 (e.g., inner portion 84) of the edge portion 66. It is appreciated that this may be accomplished in a generally parallel manner relative to and between the inboard exterior surface portion 46 of the pin bore 34 and the exterior surface 86 of the slide pin 18. It is further appreciated that the inboard exterior surface portion 46 may be radially displaced outward relative to the outboard exterior surface portion 48 so that the hinge portion 88 may extend to the lid portion 98. In one aspect, the hinge portion 88 may extend through bends 100 to the lid portion 98. The lid portion 98 may radially extend from the hinge portion 88 to cover the slide pin 18 (e.g., first end portion 82), though not required. The lid portion 98 may partially radially extend from the hinge portion 88 thereby forming an opening (not shown) in the pin cap 20 (e.g., lid portion 98).

Again with specific reference as shown in FIGS. 3A and 3B, the lid portion 98 may extend generally perpendicularly across the pin bore 34 to completely cover (e.g., encapsulate) the slide pin 18 In doing so, the pin cap 20 forms a seal radially extending from the peripheral of the cap groove 34 so that the slide pin 18 (and the pin bore 34) may be substantially or completely prevented from exposure to the surrounding environment.

The hinge portion 88 may be utilized as a biasing member for displacing one or more portions of the pin cap 20 upon contact thereof and then returning the respective portion(s) of the pin cap 20 generally back to the previous position upon removal of the contact thereon. For example, as shown in FIG. 3B, the slide pin 18 is generally free of contact with the lid portion 98. The lid portion 98 may be flat, (e.g., sloping or otherwise), arcuate, or otherwise, or any combination thereof. In one embodiment, the lid portion 98 may be displaced outboard relative to the hinge portion (e.g., cross-section being concaved or otherwise). Upon movement of one or more components of the caliper 10 (e.g., support bracket 12, caliper body 16, support pin 18, or otherwise, or any combination thereof such that the end portion 82 of the slide pin 18 contacts the lid portion 98, the lid portion 98 becomes deformed by being displaced inboard towards the inboard end 104 of the pin bore 34. It is appreciated that as the lid portion 98 deforms, the hinge portion 88 may bias so as to displace the outer portion 68 with the protrusions 72 such that at least one protrusion 72 further engages (e.g., through interference such as contact pressure and/or friction) the groove wall 42 to assist in substantially or completing maintaining (e.g., “locking”) the pin cap 20 within the pin bore 34 (e.g. cap groove 40). Optionally or as an alternative, it is further appreciated that as the lid portion 98 deforms, the hinge portion 88 may bias so as to displace the inner portion 84 with projection 92 such that the projection 92 engage the exterior surface 86 of the slide pin 18 to assist in substantially or completing maintaining (e.g., “locking”) the pin cap 20 within the pin bore 34 (e.g. cap groove 40). Accordingly with reference to FIG. 6B, a substantially deformed pin cap 20 is shown. In the deformed position, the pin cap 20 (e.g., edge portion 66) may be substantially or completely maintained within the cap groove 40 so that the slide pin 18 (e.g., end portion 82) may be substantially prevented from protruding through the inboard end portion 104 of the pin bore 34. Upon removal of contact by the slide pin 18, the hinge portion 88 returns the lid portion 98 generally back to its previous position as shown in FIG. 3B.

It is appreciated that being generally free of contact by the slide pin 18, the pin cap 20 may be in compression such that hinge portion 88, the edge portion 66 (e.g., outer portion 68, inner portion 84, or otherwise), or a combination of both engage the groove wall 42 and/or the inboard exterior surface portion 46, respectively, to assist in substantially or completely maintaining the pin cap 20 in position about the gap groove 40.

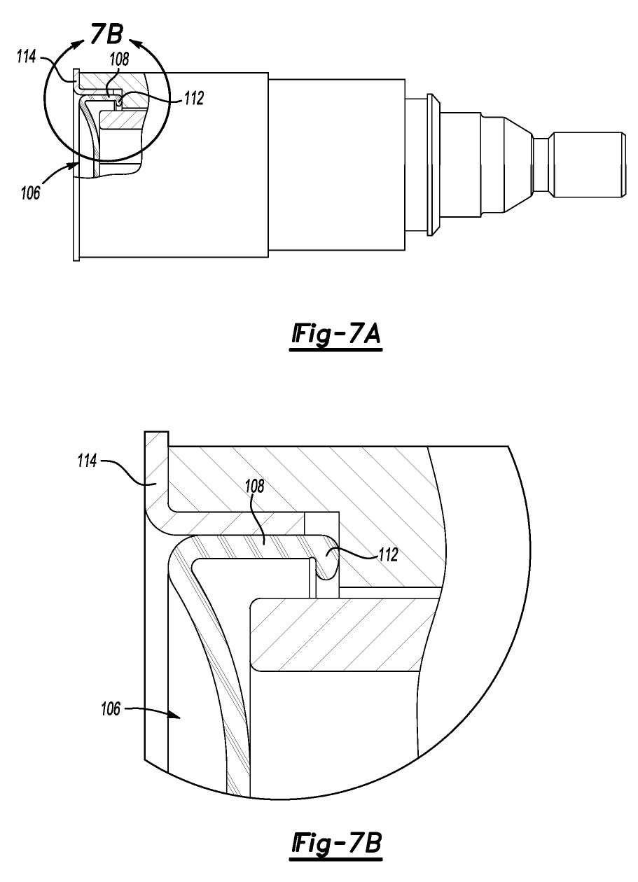

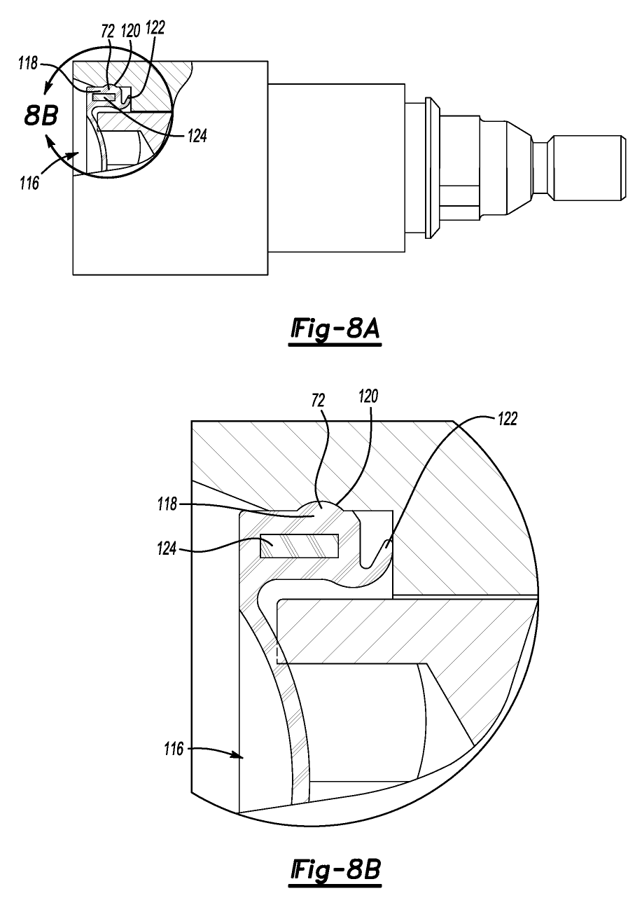

The present invention may include various embodiments for example, but not limited to FIGS. 7A-8B. The present invention may provide a boss portion 32 that includes a pin bore 34 having an opening 36 (e.g., through hole) at an inboard end 104 to receive a slide pin 18. The pin bore 34 further includes an exterior surface 38 and a cap groove 110 having groove wall 42 defining a recess into the exterior surface 38 of the pin bore 34. The groove wall 42 may extend between the inboard end 104 and the exterior surface 38 in an outward radial direction that forms a generally L-shaped cap groove profile. The L-shaped cap groove profile typically includes the outer base groove wall portion 56 that may extend generally perpendicular to the outboard groove wall portion 54.

In one aspect as shown in FIGS. 7A and 7B, the present invention may provide a pin cap 106 that may include a generally flat edge portion 108 that may extend outboard in a generally parallel manner relative to a base groove wall portion 110 of the groove wall 42. The edge portion 108 may further include a lip portion 112 at an outboard end. The lip portion 112 may extend parallel an outboard groove wall portion 112 of the groove wall 42. In one embodiment the lip portion 112 remains generally in contact with the outboard groove wall portion 112 for securement thereto (e.g., by way of a fastener, adhesive, compression, tension, or otherwise, or any combination thereof, though not required. The caliper may further include a securement member 114 that may be configured to generally correspond (e.g., conform, or otherwise) with the cap groove profile. The securement member 114 may be formed of metallic, plastic, or otherwise materials, or any combination thereof. In one specific exemplary embodiment, the securement member 114 may be generally formed of metal and the pin cap 106 may be molded onto the securement member 114 for securement to the pin bore 34.

In another aspect as shown in FIGS. 8A and 8B, the present invention may provide a pin cap 116 that may include an edge portion 118 having an outer potion with at least one protrusion 72 for engaging at least one depression 120 of the outer base groove wall portion 56 and a lip portion 122 for engaging outboard groove wall portion 54 of the cap groove 40 (e.g., L-shaped cap groove profile). However, in one embodiment, the outer base groove wall portion 56 may include the protrusion 72 while the outer portion includes the at least one depression 120 for engagement therewith. The edge portion 118 may further include an insert member 124. The insert member 124 may be partially or completely encapsulated by the edge portion 118. The insert member 124 may be utilized as a biasing member for applying an outward force against the cap groove 42 to assisting in substantially or completely maintaining the edge portion 118 therein, as a reinforcement member to add rigidity to the pin cap 20, or a combination of both. When included, the insert member 124 may be formed of metallic, plastic, or otherwise materials, or any combination thereof.

It is appreciated that when referring to securing, attaching, engaging, maintaining, or otherwise may be accomplished by any know means such as, but not limited to fasteners, adhesives, pressure interference (e.g., compression or tension), friction interference, or otherwise, or any combination thereof. In one embodiment, the pin cap may be maintained within the pin bore (e.g., cap groove) through interference (e.g., pressure and/or friction), though not required unless otherwise stated.

It is further appreciated that the pin cap may be substantially or completely positioned within the pin bore generally before, during, and after deformation thereof. In doing so, the pin cap and the slide pin may be generally protected by the pin bore such that the pin cap and/or the slide pin may not be removed (e.g., “knocked off”) by contact from the surrounding environment (e.g., contact caused during shipment of the caliper, installation of the caliper, operation of the vehicle, rock pecking, or otherwise).

It is further appreciated that the ability to deform the pin cap of the present invention to accommodate for movement of the caliper body and contact with the slide pin provides for a smaller spacing between the pin cap and the slide pin within the pin bore relative to a pin cap that has limited or no ability to deform. Advantageously, when included an internal deformable pin cap is utilized, the caliper may be formed having a reduced package size thereby decreasing manufacturing costs (e.g., shipping costs, packaging costs, or otherwise) relative to calipers utilizing limited deformable pin caps and external pin caps and/or boot seals that encapsulate the inboard end portion of the pin bore.

It is further appreciated that the pin cap (e.g., lid portion) may completely cover the slide pin. Desirably, the pin cap may form a seal within the pin bore. In doing so, the slide pin and/or the pin bore may be substantially or completely prevented from exposure to the surrounding environment. Advantageously, when the internal sealing pin cap is included, the caliper may be free of an external cap and/or boot seal encapsulating the inboard end of the pin bore so as to reduce manufacturing costs.

It is further appreciated that the internal pin cap provides improvements in manufacturing since generally minimal or no additional casting features may be needed to be incorporated outside of the pin bore for external attachment of an external pin cap and/or boot seal so that machining may not be interrupted or may be simplified. Furthermore it is contemplated that an internal pin cap design may eliminate the need for spot facing the opening of pin bore for receiving the slide pin.

It is further appreciated that the lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface.

It is further appreciated that the at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore.

As will be appreciated from the teachings in the written description above, particularly taking into consideration the accompanying drawings, the article carriers of the invention herein (including but not limited to any of the article carriers summarized herein with respect to the first, second or third aspects of the invention) may be further characterized by one or any combination of the following features: the caliper (e.g., boss portion) may be free of external cap grooves for receiving portions of pin caps, boot seals, or otherwise, or any combination thereof for encapsulating at least a portion or entirely the exterior of the inboard end portion (e.g., opening) of the pin bore; the caliper may be free of an external pin cap for encapsulating at least a portion or entirely the exterior (e.g., opening) of the inboard end portion of the pin bore; the caliper may be free of an external boot seal for encapsulating at least a portion or entirely the exterior (e.g., opening) of the inboard end of the pin bore; the caliper may be free of a metallic internal plug; the caliper may be free of any internal plug that may extend through the pin bore opening such that a substantial portion of the internal plug that may extend outward of the inboard end of the pin bore; the pin cap engages the groove wall through compression forces; the pin cap is free of threaded (e.g., the pin cap is screwed into the pin bore) engagement to the pin bore; the pin cap is free of external engagement to the pin bore such that the pin bore is free of engagement to an exterior surface of the caliper (e.g., boss portion); the caliper includes a gap within the pin bore such that the pin cap is recessed within the pin bore and there is a space between the lid portion of the pin cap (e.g., the pin cap free of contact such as not being displaced) and the inboard end portion (e.g. the opening) of the pin bore, or any combination thereof.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

1. A caliper for a disc brake comprising:
a. at least one slide pin including an exterior surface and a first end;
b. a caliper body including at least one pin bore for receiving the at least one slide pin at an inboard end, the at least one pin bore has an exterior surface and a cap groove that includes a groove wall defining a recess into the exterior surface of the at least one pin bore; and
c. at least one pin cap that includes:
i. an edge portion that is engageable with the groove wall of the cap groove; and
ii. a hinge portion extending in between the edge portion and a lid portion, the hinge portion including at least one bend that displaces the lid portion relative to the hinge portion to allow for deformation of the at least one pin cap;
d. wherein upon the first end of the at least one slide pin contacting the lid portion so as to deform the lid portion, the hinge portion displaces the edge portion to engage the groove wall of the cap groove such that the edge portion is substantially or completely maintained within the cap groove thereby substantially retaining the at least one slide pin within the at least one pin bore.

2. The caliper of claim 1, wherein the edge portion extends peripherally along the cap groove so as to form a seal therein.

3. The caliper of claim 1, wherein the edge portion includes an outer portion having at least one protrusion for engaging the groove wall of the cap groove to assist in substantially or completely maintaining the edge portion of the at least one pin cap within the cap groove.

4. The caliper of claim 3, wherein the outer portion of the edge portion includes an inboard protrusion and an outboard protrusion that are spaced apart for engaging the groove wall of the cap groove.

5. The caliper of claim 3, wherein the edge portion includes an inner portion having at least one projection that is engageable with the exterior surface of the at least one slide pin.

6. The caliper of caliper of claim 5, wherein upon the first end of the at least one slide pin contacting the lid portion of the at least one pin cap so as to displace the lid portion inboard, the inner portion of the edge portion displaces inward towards the exterior surface of the at least one slide pin so that the at least one projection engages the exterior surface of the at least one slide pin to assist in substantially or completely preventing the pin cap from being removed from the at least one pin bore.

7. The caliper of claim 1, wherein the at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore.

8. The caliper of claim 1, wherein the lid portion radially extends from the hinge portion to generally enclose the at least one pin bore such that the at least one pin cap forms a seal therein to assist in substantially or completely preventing exposure from the surrounding environment.

9. The caliper of claim 1, wherein the cap groove is positioned at a distance from an inboard end of the at least one pin bore such that the at least one pin cap prior to, during, or after deformation is substantially or completely within the at least one pin bore.

10. The caliper of claim 1, wherein the lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface.

11. The caliper of claim 1, wherein the cap groove forms a generally L-shaped groove profile that extends to an inboard end portion of the at least one pin cap such that a securement member at least partially encapsulates the inboard end of the at least one pin cap and an outer groove wall portion of the cap groove, and wherein the securement member including a wall portion that engages the outer groove wall portion along an outer surface and is attached to the edge portion along an inner surface, and further wherein the edge portion is generally flat an extends generally parallel to the groove wall.

12. The caliper of claim 1, wherein the edge portion includes:
i. an outer portion having at least one protrusion for engaging at least one depression forming in the groove wall of the cap groove;
ii. an inner portion having a lip portion engaging the groove wall of the cap groove; and
iii. an insert member being at least partially disposed with the edge portion of the at least one pin cap; and
iv. wherein the at least one protrusion, the lip portion, the insert member, or any combination thereof assists in substantially or completely maintaining the at least one pin cap within the at least one pin bore.

13. The caliper of claim 1, wherein:
i. the exterior surface of the at least one pin bore includes an inboard exterior surface portion nearest to an inboard end of the at least one pin bore and an outboard exterior surface portion, with the cap groove extending therebetween;
ii. the inboard exterior surface portion is displaced radially outward of the outboard exterior surface portion; and
iii. the groove wall extends between the inboard and outboard exterior surface portions of the at least one bore, the groove wall including an inboard groove wall portion extending generally perpendicularly from the inboard exterior surface portion, and outboard groove wall portion extending generally perpendicularly from the outboard exterior surface portion, and an outer groove wall portion extending therebetween.

14. A caliper for a disc brake comprising:
a. at least one slide pin including an exterior surface and a first end;
b. a caliper body including at least one pin bore for receiving the at least one slide pin at an inboard end, the at least one pin bore has an exterior surface and a cap groove that includes a groove wall defining a recess into the exterior surface of the at least one pin bore;
c. at least one internal pin cap including:
i. a peripheral edge portion that is engageable with the groove wall of the cap groove, the peripheral edge portion includes:
(a) an outer portion that generally conforms to the recess of the cap groove, wherein the outer portion includes a least one protrusion engaging the groove wall such that a seal is formed therebetween for assisting in peripherally sealing the at least one pin bore; and
(b) a displaceable inner portion having at least one projection that is engageable with the exterior surface of the at least one slide pin to assist in substantially or completely maintaining the edge portion of the at least one pin cap within the cap groove;
ii. a hinge portion extending in between the inner portion of the peripheral edge portion and a lid portion of the at least one pin cap, the hinge portion assists in displacing the inner portion of the peripheral edge portion to engage the exterior surface of the at least one slide pin;
d. wherein the at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore.

15. The caliper of claim 14, wherein the outer portion includes an inboard protrusion and an outboard protrusion that are spaced apart for engaging the groove wall of the cap groove to form the seal.

16. The caliper of caliper of claim 15, wherein upon the first end of the at least one slide pin contacting the lid portion of the at least one pin cap so as to displace the lid portion inboard, the inner portion of the edge portion displaces inward towards the exterior surface of the at least one slide pin so that the at least one projection engages the exterior surface of the at least one slide pin to assist in substantially or completely maintaining the edge portion of the at least one pin cap within the cap groove.

17. The caliper of claim 14, wherein the lid portion radially extends from the hinge portion to substantially or completely enclose the at least one pin bore such that the at least one pin cap to assist in substantially or completely preventing exposure from the surrounding environment.

18. The caliper of caliper of claim 17, wherein the cap groove is positioned at a distance from an inboard end of the at least one pin bore such that the at least one pin cap prior to, during, or after deformation is substantially or completely within the at least one pin bore.

19. The caliper of claim 18, wherein the lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface.

20. A caliper for a disc brake comprising:
a. a support bracket including a pair of spaced apart frame members at opposite ends of the support bracket
b. at least one slide pin that includes an exterior surface:
c. a caliper body including at least one pin bore for receiving the at least one slide pin at an inboard end portion, the at least one pin bore includes:
i. an exterior surface having an inboard exterior surface portion nearest to the inboard end portion of the at least one bore and an outboard exterior surface portion;
ii. a cap groove having a groove wall extending between the inboard and outboard exterior surface portions, the groove wall defining a recess into the exterior surface of the at least one pin bore and includes an inboard groove wall portion extending from inboard exterior surface portion, an outboard groove wall portion extending from the outboard exterior surface portion, and an outer groove wall portion extending therebetween;
d. at least one internal pin cap that includes:
i. a peripheral edge portion having:
(a) an outer portion generally corresponding to the cap groove for engaging the groove wall thereabout so that the outer portion assists in substantially or completely maintaining the edge portion within the cap groove, wherein the outer portion includes a least one protrusion engaging the groove wall such that a peripheral seal is formed therebetween to assist in substantially or completely sealing at least a portion of the at least one pin bore;
(b) an inner portion having at least one projection that is engageable with the exterior surface of the at least one slide pin to assists in substantially or completely maintaining the at least one pin cap within the pin bore; and
ii. a hinge portion extending in between the inner portion of the peripheral edge portion and a lid portion of the at least one pin cap, wherein the lid portion radially extends from the hinge portion to substantially or completely enclose the at least one pin bore such that the at least one pin cap to assist in substantially or completely preventing exposure from the surrounding environment, and wherein the hinge portion includes at least one bend that displaces the lid portion relative to the hinge portion to allow for deformation of the at least one pin cap;
e. wherein:
i. the at least one pin cap is in compression such that a compression force by the hinge portion is formed to engage the exterior surface of the at least one pin bore, the groove wall, or a combination of both so as to assist in substantially or completely maintaining the at least one pin cap in position within the at least one pin bore;
ii. the cap groove is positioned at a distance from the inboard end of the at least one pin bore such that the at least one pin cap prior to, during, or after deformation is substantially or completely maintained within the at least one pin bore;
iii. upon the first end portion of the at least one slide pin engages the lid portion so as to displace the lid portion outward, the inner portion of the edge portion is displaced towards the at least one slide pin such that the at least one projection engages the exterior surface of the at least one slide pin to assist in substantially or completely preventing the pin cap from being removed from the at least one pin bore; and
iv. the lid portion is displaced outboard of the hinge portion so as to form a generally concave surface that is deformable inwardly towards an inboard end portion the at least one pin bore to form a generally convex surface upon contact thereto and upon removal of the contact, the generally convex surface reforms back to the generally concave surface.
